(19) United States
(12) Patent Application Publication
(10) Pub. No.: US 2019/0353529 A1
(43) Pub. Date: Nov. 21, 2019

(54) TEMPERATURE LIMIT VALUE SENSOR

(71) Applicant: Endress+Hauser Wetzer GmbH+Co. KG, Nesselwang (DE)

(72) Inventor: Marc Schalles, Erfurt (DE)

(21) Appl. No.: 16/476,867

(22) PCT Filed: Dec. 8, 2017
(86) PCT No.: PCT/EP2017/082040

§ 371 Date: Jul. 9, 2019

(30) Foreign Application Priority Data
Jan. 9, 2017 (DE) 10 2017 100 266.9

(51) Int. Cl. G01K 3/00; G01K 7/38; G01K 7/32

(52) U.S. Cl. CPC G01K 3/005; G01K 7/343; G01K 7/32; G01K 7/38

(57) ABSTRACT

The present disclosure relates to a system for monitoring a predeterminable temperature comprising a monitoring unit comprising a reference element composed at least partially of a material in which a phase transformation occurs at a phase transformation temperature, which lies in the region of the predetermined temperature, in which phase transformation the material remains in the solid phase, and a detection unit embodied to detect the occurrence of the phase transformation based on an abrupt change at least one physical or chemical parameter characteristic for the reference element and to generate a report concerning ex- or subceeding of the predeterminable temperature. Furthermore, the present disclosure relates to a monitoring unit and to a detection unit for application in a system of the disclosure as well as to a method for monitoring the predeterminable temperature by means of a system of the disclosure.

The invention relates to a system for monitoring a predeterminable temperature, comprising a monitoring unit and a detection unit, as well as to a method for monitoring a predeterminable temperature. Involved, thus, in principle, is a temperature limit value sensor. By means of the system of the invention, it can be monitored whether a predeterminable temperature, for example, of a measured liquid, a material or a mixture of materials, or an item, for example, a part, or a component, was ex- or subceeded, i.e. exceeded or fallen beneath.

The temperature can be determined by means of a thermometer continuously within a certain temperature range, for which the thermometer is embodied. Thermometers are available in the most varied of embodiments. Thus, there are thermometers, which for measuring temperature use the expansion of a liquid, a gas or a solid body of known coefficient of expansion, or also such, which relate the electrical conductivity of a material to temperature, such as, for example, in the case of applying resistance elements or thermocouples. In contrast, radiation thermometers, especially pyrometers, utilize thermal radiation for determining temperature of a substance. The underpinning measuring principles of each of these are described in a large number of publications and are, thus, not detailed here.

In principle for determining a temperature, the most varied of physical and/or chemical, temperature dependent, material properties can be used. In such case, the property can be either a change, especially an abrupt change, of a particular property, occurring at a certain characteristic temperature point or a continuous change of a property, for example, in the form of a characteristic line or curve. For example, the Curie temperature of a ferromagnetic material is a characteristic temperature point for the material. In this regard, known from DE4032092C2 is a method for ascertaining the Curie temperature, in the case of which by means of a differential scanning thermal analyzer an abrupt change of the absorbed amount of heat is detected in the region of the Curie temperature.

In reference to a continuous change of a temperature dependent property of a material, described in DE19702140A1 are a device and a method for measuring temperature of a rotating support part with a temperature sensor, which has a temperature-dependently sometimes ferro- and sometimes para-magnetic material, which exhibits a temperature dependent change of its polarization in a temperature range of interest. Also, DE04006885A1 concerns a contactless temperature measurement involving a moved, i.e. transported, preferably rotating, body. Placed on the moved body is an LC-combination, which includes in an embodiment a ferroelectric dielectric, and a temperature dependent, resonant frequency of the LC-combination is considered. Thus, a characteristic line or curve of temperature dependent polarization is taken into consideration for determining temperature.

A further example known from DE19805184A1 describes the ascertaining of temperature of a piezoelectric element based on its capacitance. Similarly, patent DE69130843T2 concerns a method and a device for determining temperature of a piezoelectric crystal oscillator.

DE102013019839A1 describes a temperature sensor with a sensor element for passively determining temperature using temperature dependence of the permittivity of at least one ferroelectric material. The temperature measurement occurs, in such case, based on travel time differences within the sensor element. Known from DE010258845A1 is, finally, a temperature measuring device having a capacitive element containing an electrically contacted, dielectric material, which changes its dielectric properties with temperature.

Corresponding physical and/or chemical, specific, temperature dependent material properties are suited basically also for calibrating and/or validating thermometers. For example, known from DE102010040039A1 are a device and a method for in-situ calibration of a thermometer having a temperature sensor and a reference element for calibrating a temperature sensor, in the case of which the reference element is composed at least partially of a ferroelectric material, which experiences a phase transformation at at least one predetermined temperature in a temperature range relevant for calibrating the temperature sensor. The calibration is thus based on the characteristic temperature point of a phase transformation of a ferroelectric material, thus performed based on a material-specific property. Depending on number of installed reference elements, in this way, both a so-called 1-point-as well as also a multipoint-calibration and/or validation can be performed. A similar device, especially suitable for multipoint calibrations, is known, furthermore, from German patent application No. 102015112425.4, which was unpublished at the date of first filing of this application. The thermometer described there includes at least one temperature sensor and at least two reference elements contacted via exactly two connection wires. The reference elements are composed at least partially of two different materials, each of which has in a temperature range relevant for calibrating the temperature sensor at least one phase transformation at least of second order at, in each case, a predetermined phase transformation temperature. DE 102010040039A1 (U.S. Pat. No. 9,091,601) as well as DE 102015112425.4 (US 2018217010) are incorporated here by reference.

Besides a continuous temperature determination, there are many applications, in which it must be assured that a certain temperature is not ex- or subceeded. In this regard, known, for example, from DE102006031905A1 is a device for determining and/or monitoring at least one process variable of a liquid, comprising a sensor unit, a housing and a temperature exceeded element. The temperature exceeded element is placed in or on the housing and includes a piezoelectric element, wherein the Curie temperature of the piezoelectric element is selected in such a manner that the Curie temperature lies in the region of a monitored temperature of the device. In order to find out, whether the monitored temperature is exceeded, however, disadvantageously, the temperature exceeded element must be removed from the housing, or, however, be embodied in such a manner that the polarization of the temperature exceeded element is queryable in the installed state. This requires a special embodiment of the measuring device.

Starting from the state of the art, an object of the present invention is to provide a simple and universally usable system, by means of which temperature limit values can be monitored in simple manner.

The object is achieved by the system as defined in claim 1, by the monitoring unit as defined in claim 14, by the detection unit as defined in claim 15 as well as by the method as defined in claim 16.

As regards the system, the object of the invention is achieved by a system for monitoring a predeterminable temperature, comprising
a monitoring unit comprising a reference element, which is composed at least partially of a material, in the case of which at least one phase transformation occurs at a phase transformation temperature, which lies in the region of the predetermined temperature, in which phase transformation the material remains in the solid phase, and
a detection unit, which is embodied to detect the occurrence of the phase transformation based on an, especially abrupt, change of at least one physical or chemical parameter characteristic for the reference element and to generate a report concerning ex- or subceeding of the predeterminable temperature.

Thus, the invention involves a temperature limit value sensor. By means of the system of the invention, it can be monitored in simple manner, whether a predeterminable temperature, for example, of a measured liquid, a material or a mixture of materials, or an item, for example, a part, or a component, was ex- or subceeded. The predeterminable temperature is especially a predeterminable limit temperature. Depending on concrete embodiment, it is advantageously only necessary to position the monitoring unit suitably, for example, in the direct vicinity of a particular measured liquid, material or substance mixture, or in the immediate vicinity of a particular item, for example, a part, or a component. The monitoring unit is thus preferably arranged in such a manner that it is exposed to the same temperature.

The detection unit can either be arranged together with the monitoring unit or alternatively be embodied as an independent unit, which is applied as needed. However, also integration of the detection unit in an electronics unit, for example, of a measuring device or in an electronic component is an option. Depending on the contemplated application, thus a monitoring of the predeterminable temperature can occur continuously, or the ex- or subceeding of the predeterminable temperature can be checked as needed, for example, at predeterminable points in time or in predeterminable time intervals.

In the case of a phase transformation in a material, which remains in the solid phase, involved, for example, according to the Ehrenfest classification, is a phase transformation at least of second order. In contrast with a phase transformation of first order, no or only a negligible amount of latent heat is released during the phase transformation. When no or only a negligible amount of latent heat is released, it can—basically and independently of the selected classification for phase transformations —, among other things, be advantageously assured that the temperature measured by means of the temperature sensor at the point in time of the occurrence of a phase transformation is not corrupted, especially not by released, latent heat.

In an additional classification of phase transformations significantly more usual in the present state of the art, it is distinguished only between discontinuous (first order) and continuous (second order) phase transformations [compare e.g. Lexikon der Physik, Spektrum Akademischer Verlag, Heidelberg, Berlin, Vol. 4, under the entry “Phasenubergange and andere kritische Phänonnene” (Phase Transformations and Other Critical Phenomena)]. According to this classification, various ferroelectric materials can be associated with both phase transformations of first as well as also second order, wherein in both cases the particular material, for which a phase transformation occurs, remains in the solid phase during the phase transformation.

The remaining in the solid phase is important for the present invention independently of the selected classification of a phase transformation. A material remaining in the solid state is especially advantageous with reference to structural aspects of the system, especially the monitoring unit.

One or more reference elements can be provided for the system of the invention, wherein each reference element can have one or more phase transformations. Thus the system can also monitor a plurality of predeterminable temperatures. For example, in the case of monitoring a determinable maximum temperature, upon reaching a first predeterminable temperature, a warning can be output. This first temperature has a predeterminable temperature separation from the chosen maximum allowable temperature. Upon reaching a second predeterminable temperature, which has a lesser temperature separation from the maximum allowable temperature than the first predeterminable temperature, then, for example, a renewed warning can be output. Alternatively, also a control signal can be generated, by means of which a safety function, for example, a turnoff procedure of a component or the like, is performed.

Since the chosen phase transformation basically occurs at a certain characteristic, fixed and long term stable temperature value, advantageously in principle, no drift and/or no aging effects need to be taken into consideration.

In an embodiment, the material is a ferroelectric material, a ferromagnetic material, or a superconductor, especially a high temperature superconductor. The at least one phase transformation is correspondingly a phase transformation from the ferroelectric into the paraelectric state or vice versa, from the ferromagnetic into the paramagnetic state or vice versa, or from the superconducting state into the normally conducting state or vice versa.

Fundamentally associated with the occurrence of a phase transformation is the change of a specific material property. In the case of the present invention, the material-specific changes for the material, of which the particular reference element is composed, are at least partially known and can be taken into consideration for monitoring the predeterminable temperature.

In an embodiment of the system of the invention, the characteristic physical or chemical parameter is a dielectric, electrical, or magnetic property of the material, for example, a magnetic or electrical polarization or remanence, a capacitance or an inductance, or a crystal structure or a volume.

A number of possible embodiments of the monitoring unit and the detection unit will now be discussed. The embodiments do not represent an exclusive listing, but, rather, especially preferred embodiments for the system of the invention. The different embodiments are, furthermore, combinable with one another as much as desired.

An embodiment provides that the reference element is a capacitor element having a dielectric, wherein the dielectric is at least partially composed of the material, in the case of which the at least one phase transformation occurs at the predetermined phase transformation temperature. For this embodiment, it is correspondingly expedient to detect the occurrence of the at least one phase transformation based on a capacitance or on a variable dependent on capacitance.

An alternative embodiment includes that the reference element is a coil arrangement having at least one coil and a magnetically conductive body, wherein the body is composed at least partially of the material, in the case of which the at least one phase transformation occurs at the predetermined phase transformation temperature. In the case of this embodiment, it is, in turn, expedient to detect the at least one phase transformation based on an inductance or a variable dependent on the inductance.

In an embodiment, the detection unit includes means for detecting the change of a field, especially an electrical or magnetic field, leaving the reference element, wherein the detecting unit is embodied to detect the ex- or subceeding of the predeterminable temperature based on a change of the field. During the phase transformation, for example, the polarization of the material, which undergoes the phase transformation, can change. This is especially true for ferroelectric and ferromagnetic materials.

In such case, it is advantageous that the means for detecting a change of the field comprise means for detecting a force or a change of force. A change of a force indicates, for example, in simple manner, a change of the polarization state of the chosen material.

Another embodiment provides that the detection unit and/or monitoring unit includes means for applying an, especially electrical, or magnetic, field. Preferably, the means for applying the field are embodied in such a manner that the field passes, at least at times and at least partially, through at least one component of the reference element, especially the at least one component, which is at least partially composed of the material, for which the at least one phase transformation occurs. The field can, on the one hand, be manually applied, for example, by a user of the system. The field can, however, also be applied in predeterminable time intervals or continuously during operation of the system. For this embodiment, it is advantageous that the detection unit be embodied to detect the ex- or subceeding of the predeterminable temperature based on at least one hysteresis diagram and/or based on polarization.

In an additional embodiment of the system, at least the reference element and at least one other component of the monitoring unit and/or detection unit are, at least a times, part of an electrical oscillatory circuit, wherein the detecting unit is embodied to detect the occurrence of the phase transformation by a change of a resonant frequency of the oscillatory circuit.

Independently of the particular measuring principle for detecting the occurrence of a phase transformation, the system according to an embodiment of the present invention includes an output unit, which is embodied to display, to output and/or to transmit into an external unit the ex- or subceeding of the predetermined temperature. The output unit is, for example, associated with the detection unit.

In an additional embodiment, the system includes a transmission unit, especially a transmission unit comprising an RFID- or a Bluetooth module, which transmission unit is embodied for wireless transmission of at least the ex- or subceeding of the predetermined temperature. Upon detecting the phase transformation based on a change of the resonant frequency of an oscillatory circuit, for example, the particular resonant frequency can be transmitted by means of the transmission unit. Likewise, from the change of the resonant frequency, a transmission property of the transmission unit, for example, a sending frequency or an excitation frequency, or excitation sensitivity, can be modified. This relates especially to passive RFID modules.

An embodiment comprising a transmission unit is distinguished basically by an especially simple construction.

Advantageously, the system further includes an energy supply unit for supplying electrical power to at least one component of the monitoring unit, the detection unit, the output unit and/or the transmission unit. The system, or at least one component of the system, can thus be embodied in such a manner that it works autarkically from an external energy supply. This is especially advantageous when the monitoring unit and detection unit are embodied as separate units. For example, a mobile detection unit can be used for detecting the occurrence of a phase transformation in a plurality of monitoring units.

The object of the invention is achieved, furthermore, by a monitoring unit for application in a system of the invention, as well as by a detection unit for application in a system of the invention.

Furthermore, the object of the invention achieved is by a method for monitoring a predeterminable temperature by means of a system of the invention, comprising method steps as follows:
detecting a phase transformation based on at least one, especially abrupt, change of at least one physical or chemical parameter characteristic for the reference element, and
generating a report concerning ex- or subceeding of the predeterminable temperature when a phase transformation is detected.

The embodiments explained in connection with the system can be applied mutatis mutandis also for the transmission unit, the detection and/or the method, and vice versa.

The invention will now be explained in greater detail based on the appended drawing, the figures of which show as follows:

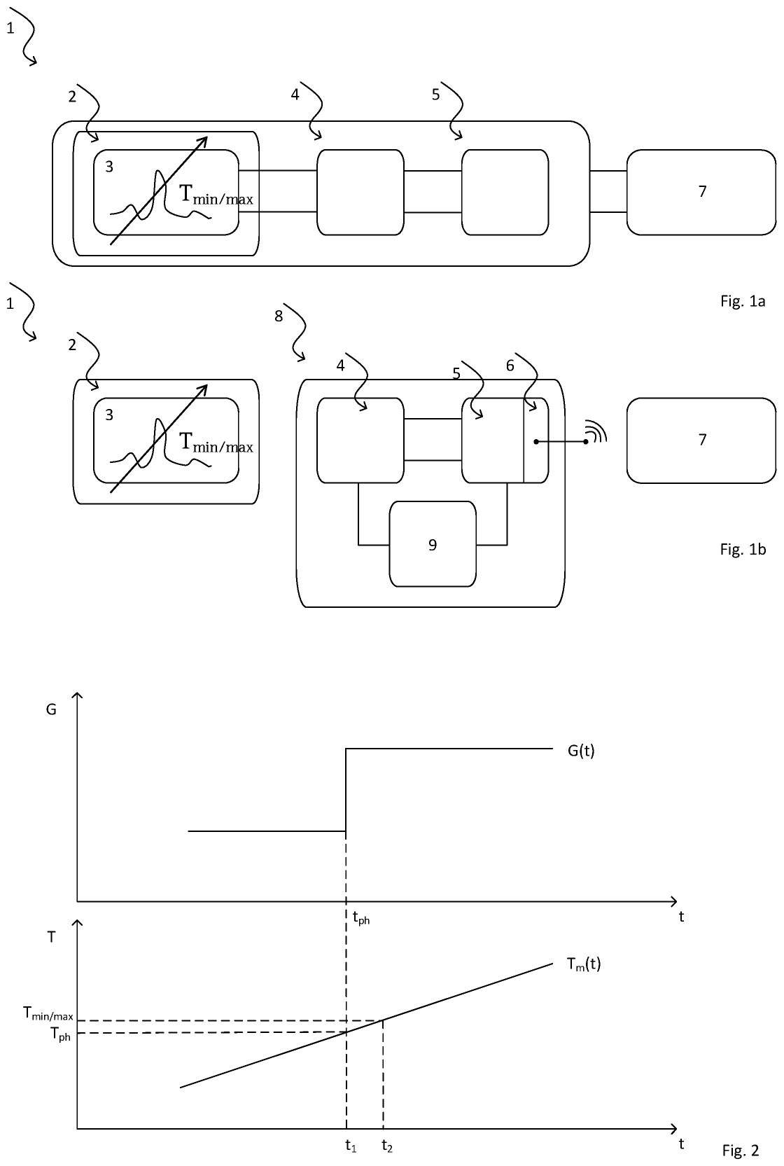

FIG. 1 a schematic representation of a system of the invention with a monitoring unit and detection unit, which a) are arranged together and b) separately from one another,

FIG. 2 a schematic representation of the line or curve as a function of time of a characteristic parameter as well as of temperature for illustrating detecting the phase transformation based on a change of the parameter,

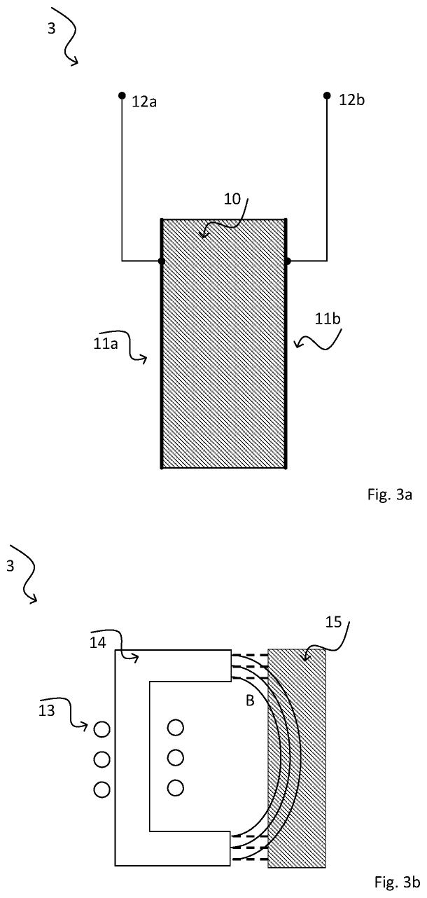

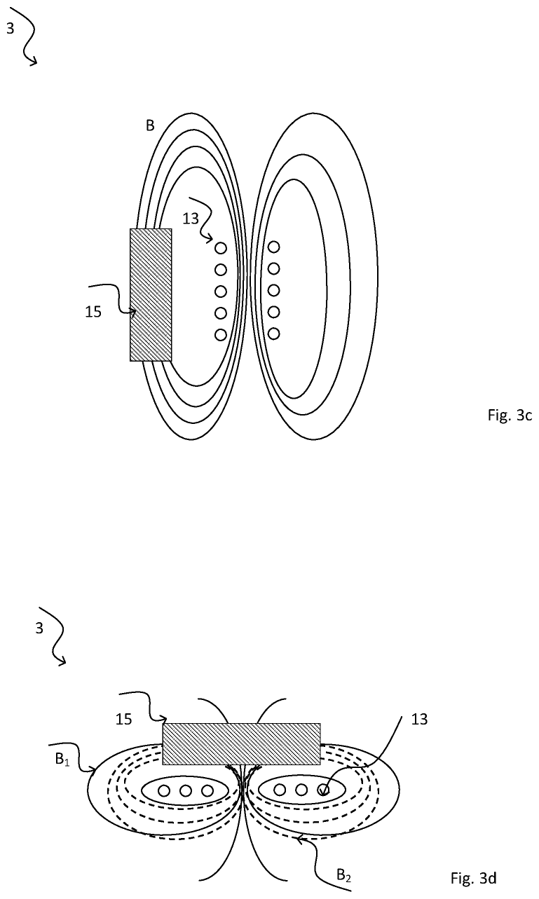

FIG. 3 a schematic representation of an embodiment of the reference element as (a) capacitor element and (b) as a coil arrangement,

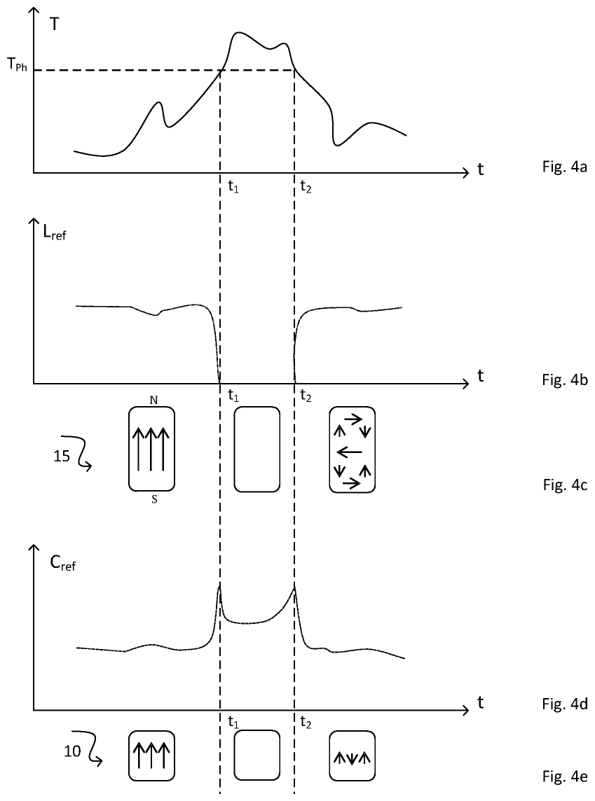

FIG. 4 detecting a phase transformation based on a change of the polarization of the material, of which the reference element is at least partially composed,

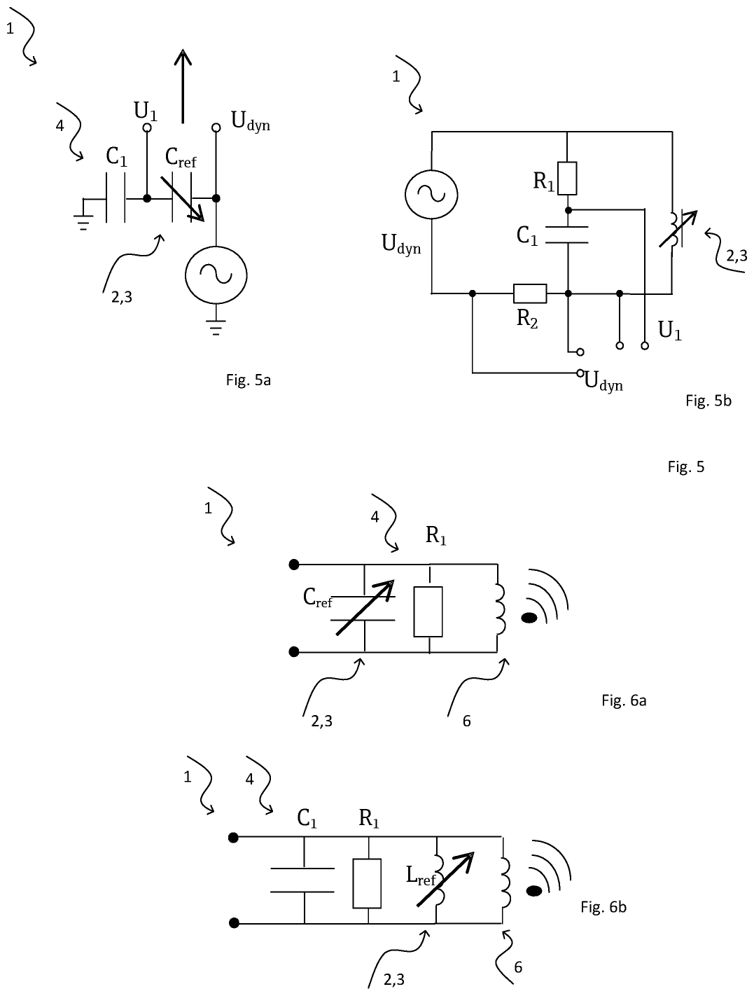

FIG. 5 detecting a phase transformation based on a hysteresis diagram, for the case of (a) a ferroelectric and (b) a ferromagnetic phase transformation, and

FIG. 6 detecting a phase transformation based on the resonant frequency of an oscillatory circuit with a reference element in the form of an (a) inductance and (b) capacitance.

In the figures, equal elements are provided, in each case, with equal reference characters.

FIG. 1 shows schematically, by way of example, two embodiments of systems 1 of the invention. Many other embodiments and arrangements of the individual components are possible and fall within the scope of the present invention. In each case, there is a monitoring unit 2, which has a reference element 3, which is at least partially composed of a material, in the case of which there occurs at a phase transformation temperature Tₚₕ, which lies in the region of the predetermined temperature T_{min/max}, at least one phase transformation, in which the material remains in the solid phase. Furthermore, each system 1 includes a detection unit 4, with which the occurrence of the phase transformation is detected based on an, especially abrupt, change of at least one physical or chemical parameter characteristic for the reference element 3 and a report generated concerning ex- or subceeding of the predeterminable temperature T_{min/max}. This report can, for example, be output by means of an output unit 5, and/or transmitted into an external unit 7.

Monitoring unit 2 and detection unit 4 can either be arranged together, as shown in FIG. 1 a, or embodied as separate units separated from one another, as shown in FIG. 1b. Communication between the monitoring unit 2 and the detection unit 4 can occur both by wire as well as also wirelessly.

FIG. 1a shows the monitoring unit 2 with the reference element 3 in direct contact with detection unit 4, which, in turn, is in direct contact with an output unit 5. By means of the output unit 5 in this example of an embodiment, a report concerning ex- or subceeding of the predeterminable temperature T_{min/max} is transmitted by wire to the external unit 7. The system 1 of FIG. 1a is essentially embodied in the form of a single component.

In contrast, the sending of the ex- or subceeding of the predeterminable temperature T_{min/max} to the external unit 7 in the embodiment of FIG. 1b occurs wirelessly by means of the transmission unit 6. Detection unit 4 in this embodiment is embodied as an independent unit 8. This unit 8 includes the detection unit 4, the output unit 5 and the transmission unit 6. Furthermore, unit 8 includes an energy supply unit 9, which supplies the detection unit 4, the output unit 5 and the transmission unit 6 with electrical energy. Unit 8 is correspondingly autarkically fed from an energy supply and can be applied in a mobile manner.

The occurrence of the at least one phase transformation of the invention is detected based on an, especially abrupt, change of at least one physical or chemical parameter characteristic for the reference element 3, as shown in FIG. 2. The upper graph shows the line or curve as a function of time of a characteristic physical or chemical variable G used for detecting the phase transformation. If a phase transformation occurs in the reference element 3, then there occurs in the illustrated example an abrupt change of the variable G. The point in time, at which the abrupt change of the variable is detected, is the phase transformation point in time tₚₕ, at which the reference element 3 achieves the phase transformation temperature Tₚₕ.

Shown in the lower graph is temperature T as a function of time t. The material, in which the phase transformation occurs, is selected in such a manner that the phase transformation temperature Tₚₕ lies in the region of the monitored, predeterminable temperature T_{min/max}. FIG. 2 is for the case, in which the predeterminable temperature T_{min/max} should not be exceeded. In this case it is expedient to choose the material of the reference element 3 in such a manner that Tₚₕ<T_{min/max}, wherein a suitable temperature separation between the phase transformation temperature Tₚₕ and the predeterminable temperature T_{min/max} is selectable depending on the application. In the case of a heating procedure of the respective measured liquid, material or mixture of materials, or a particular item, for example, a part, or a component, to a first point in time t₁ first the phase transformation temperature Tₚₕ is reached. For example, a report is generated and output concerning the reaching of the phase transformation temperature Tₚₕ. Upon additional heating to a second point in time t₂, the predeterminable temperature T_{min/max} reached. Since a predeterminable temperature separation between the phase transformation at n temperature Tₚₕ and the predeterminable temperature T_{min/max} is selected, it can, for example, be assured that between the first t₁ and second t₂ points in time, especially also in the case of additional heating, enough time remains, in order to prevent exceeding the predeterminable temperature T_{min/max}. For the case, in which the predeterminable temperature T_{min/max} should not be subceeded, analogous ideas hold, so that such does not need to be detailed here. The temperature separation between the phase transformation temperature Tₚₕ and the predeterminable temperature T_{min/max} can be selected, for example, with reference to expected heating- or cooling rates of a particular measured liquid, material or a mixture of materials, or a particular item, for example, a part, or a component. Alternatively, the material of the reference element 3 can also be selected in such a manner that the phase transformation temperature Tₚₕ and the predeterminable temperature T_{min/max} essentially correspond. In this case, the predeterminable temperature separation is essentially zero.

Some possible embodiments for the reference element 3 are shown in FIG. 3 by way of example. Suited in the case of a ferroelectric material, for example, is an embodiment of the reference element 3 in the form of a capacitor element, as shown in FIG. 3a. The material 10, in which the phase transformation occurs, forms the dielectric in this case. The reference element 3 includes, furthermore, two electrodes 11a and 11b, which in the example shown here are arranged on two directly oppositely lying, lateral surfaces of the material 10, which is embodied as an essentially cuboidal body and electrically contacted by means of the two connection lines 12a and 12b, in order, for example, to detect the capacitance C of the reference element 3 and based on an, especially abrupt, change of capacitance C to detect the phase transformation. For other details of this embodiment of the reference element 3 in the form of a capacitor element, reference is made to Offenlegungsschrift DE102010040039A1.

In the case of a reference element 3 comprising a ferromagnetic material 15, beneficial is an embodiment in the form of a coil arrangement, such as shown, by way of example, in FIGS. 3b-3d. An opportunity for detecting a phase transformation in the case of such an embodiment of the reference element 3 lies in detecting a change of the inductance L of the arrangement. Upon a phase transformation from the ferromagnetic to the paramagnetic state, the magnetic resistance of the material 15, in which the phase transformation occurs, changes, and, thus, for example, also the inductance L of the arrangement.

In the embodiment of FIG. 3b, the reference element 3 includes a coil 13 with core 14, and a magnetically conductive body 15, which is composed of the ferromagnetic material. The magnetically conductive body 15 is arranged in such a manner that it is located at least partially in a magnetic field B emanating from the coil 13 with the core 14. The magnetic field is indicated by the sketched field lines. Upon a phase transformation in the magnetically conductive body 15, the magnetic field B changes, which is detectable, for example, based on a change of the inductance L of the arrangement.

It is to be noted that the use of a core 14 for the coil 13 is optional. Two possible embodiments of the reference element 3 as a coil arrangement without core are correspondingly shown in FIGS. 3b and 3c. Shown in FIG. 3d is, furthermore, by way of example, on the one hand, the magnetic field B₁, which reigns, when the material 15 is located in the ferromagnetic state. Moreover, shown in dashed lines is the magnetic field B₂, which reigns, when the material 15 is located in the paramagnetic state.

It is to be noted, furthermore, that the material 15, the coil 13 and the core 14 do not necessarily need to be arranged together within detecting unit 4. It is likewise an option that the coil 13 and/or the core 14 is/are part/parts of the transmission unit 6.

In the case, in which the particular system 1 includes a plurality of reference elements 3, the different reference elements 3 can be of equal construction or differently embodied. Preferably used are materials with phase transformations at different phase transformation temperatures Tₚₕ₁, Tₚₕ₂, . . . . For example, at least one of the reference elements 3 can be embodied in the form of a capacitor element and at least one further reference element in the form of a coil arrangement. For detecting the phase transformations of the different reference elements 3, the detection unit 4 can, furthermore, comprise either one or, however, a plurality of measuring circuits. For example, a plurality of reference elements 3 can be integrated in a single oscillatory circuit for detecting particular phase transformations.

For detecting the occurrence of a particular phase transformation, varied options are available, which all fall within the scope of the present invention. In the next figures, some especially preferred embodiments will be explained. The invention is, however, in no way limited to the described embodiments.

An opportunity for detecting the occurrence of a phase transformation is composed in detecting a change of the polarization of a particular material 10, or 15, in which the phase transformation occurs, such as illustrated in FIG. 4. During the occurrence of a phase transformation, for example, the polarization of the material 10, or 15, in which the phase transformation occurs, can change. A change of the polarization can be recognized, for example, in the case of a ferromagnetic material, based on a change of an inductance L, such as illustrated in FIGS. 4b and 4c, or, in the case of a ferroelectric material, based on a change of a capacitance C, such as shown in FIGS. 4d and 4e.

FIG. 4a shows temperature T as a function of time t. At a first point in time t₁, a phase transformation occurs, wherein the polarization of the material 10, or 15 disappears, as shown in FIGS. 4c and 4e. Before the point in time t1, the material 10, or 15 in the case of FIG. 4c was in the ferromagnetic state and in the case of FIG. 4e in the ferroelectric state. Between the point in time t₁ and a second point in time t₂, at which anew a phase transformation occurs, the material in the case of FIG. 4c is located in the paramagnetic state and in the case of FIG. 4e in the paraelectric state. At the point in time t₂, the material, in contrast, returns to a ferromagnetic (FIG. 4c), or a ferroelectric (FIG. 4e) state. In the paramagnetic, and in the paraelectric state, the polarization of the material disappears. As a consequence, the capacitance C of the reference element 3 in the case of a ferroelectric material (FIG. 4d), or the inductance L of the reference element 3 with a ferromagnetic material 10, experiences an abrupt change, which can easily be detected.

Another opportunity for detecting a phase transformation based on polarization is composed in considering a field emanating from the reference element 3, for example, the remanence of a material. A field emanating from a material, which, at the start, is located in a ferroelectric or ferromagnetic state with high polarization, will disappear after an exceeding of the phase transformation temperature Tₚₕ. A starting state of high polarization of the utilized ferroelectric or ferromagnetic material can be produced, for example, by applying an, especially external, electrical or magnetic field.

In this case, even after a return to the ferromagnetic state, or to the ferroelectric state, as the case may be, the polarization present, in each case, no longer corresponds to the polarization in the starting state, such as indicated in FIGS. 4c and 4e for the phase transformation at the second point in time t₂.

In this regard, applications as follows are conceivable: certain items, for example, electronic assemblies, or foods, must not at any time during transport exceed a certain predeterminable temperature T_{min/max}. For monitoring the predeterminable temperature, a monitoring unit 2 comprising a reference element 3 with a ferroelectric or ferromagnetic material is placed on the item or in its immediate vicinity. The reference element 3 can be polarized at the beginning, for example, by applying an electrical or magnetic field, especially an external, electrical or magnetic field, which passes, at least at times and/or partially, at least through the material having the phase transformation.

For this embodiment, the monitoring unit 2 and the detection unit 4 are advantageously embodied as separate units.

The polarization of an item can be detected during transport by means of the detection unit 4 either continuously or in predeterminable time intervals. The occurrence of a phase transformation can then be detected based on an, especially abrupt, change of the polarization in the material, of which the reference element is at least partially composed. Alternatively, the occurrence of a phase transformation can also be checked once, especially at the end of a procedure, for example, after transport. In this case, for example, the polarizations at the beginning, thus in the starting state, and at the end can be compared. If the polarizations at the beginning and at the end are essentially unequal, then it can be determined therefrom that at least at a time the predeterminable temperature T_{min/max} was exceeded. For another application, the reference element 3 can be polarized anew by applying a suitable field. Corresponding means for applying a field can be implemented, for example, in the monitoring unit 2 or in detecting unit 4.

Similar ideas hold also for the case, in which a certain predeterminable temperature T_{min/max} must not be subceeded. This example is therefore not explained here in detail.

A detecting of a particular polarization can occur by means of a suitably embodied detection unit 4, basically, for example, using remanence. The presence of a remanence, or a polarization, can be ascertained, in such case, for example, based on a change of capacitance or inductance, such as in FIGS. 4b and 4d. Alternatively, however, also a force measurement or a measurement of a hysteresis can be performed. This example is especially advantageous for the case, in which no continuous temperature monitoring should take place, but, the ex- or subceeding of the predeterminable temperature T_{min/max} should be checked at predeterminable points in time.

In the case, in which the at least one phase transformation is detected based on a hysteresis diagram, for example, an embodiment of the reference element corresponding to one of the embodiments of FIG. 5 can be used. In the case of the embodiments shown in FIG. 5, the monitoring unit 2 and the detection unit are arranged together. The reference element 3 is, in such case, part of an electrical circuit of the detection unit 4.

For registering a hysteresis diagram, the change of the polarization of a particular material, in which the phase transformation occurs, is registered by applying a time dynamic voltage U_{dyn}. The particular hysteresis diagram results from plotting voltage U₁ as a function of U_{dyn}. The occurrence of a phase transformation can be detected, for example, based on a change of the ratio of the voltages U_{dyn} and U₁.

For the embodiment of FIG. 5a, the reference element 3 is a capacitor element with the capacitance Clef, such as, for example, in FIG. 3a. Correspondingly, a phase transformation is from the ferroelectric into the paraelectric state or vice versa. In the case of the circuit, which comprises the detection unit 4, such is a so-called Sawyer-Tower circuit, which is per se well known from the state of the art and therefore is not described in detail here.

An electrical circuit for detecting a phase transformation in the case of a reference element 3 in the form of a coil arrangement with the inductance L_{ref}, such as, for example, in one of the figures, FIG. 3b-FIG. 3d, each of which includes ferromagnetic material, is, in contrast, shown in FIG. 5b. The capacitance C₁, as well as the resistances R₁ and R₂ are, in each case, matched to the applied reference element 3.

Finally, it is likewise possible to embody the reference element 3 as part of an oscillatory circuit, such as illustrated based on FIG. 6. In this case, the occurrence of the phase transformation is detected, for example, based on a change of a resonant frequency f₀ of the oscillatory circuit. However, also other properties of the oscillatory circuit, such as, for example, an attenuation, an amplitude response, or a frequency response can be evaluated as regards the occurrence of a phase transformation.

Also in the case of the examples of embodiments in FIG. 6, the monitoring unit 2 and the detection unit 4 are arranged together, wherein the reference element 3 is part of an oscillatory circuit, which is integrated into the detection unit 4.

For the case of a reference element 3 formed as a capacitor element with capacitance Clef as shown in FIG. 6a, suited is an RC oscillatory circuit with the resistance R₁, which is suitably selected as a function of the reference element 3. A transmission unit 6, which is, for example, an element of an RFID module, can, in this case, advantageously be integrated directly into the oscillatory circuit. The phase transformation is then detected based on a change of the resonant frequency f₀ of the oscillatory circuit, which is transmitted directly by means of the transmission unit 6.

In the case of an embodiment of the reference element 3 as a coil arrangement with the inductance L_{ref}, as shown in FIG. 6b, suited is an RCL oscillatory circuit with the resistance R₁ and the capacitance C₁, both of which are selected as a function of the reference element 3. Analogously to the previous embodiment, a transmission unit 6 is integrated into the oscillatory circuit.

### LIST OF REFERENCE CHARACTERS

1 system of the invention
2 monitoring unit
3 reference element
4 detection unit
5 output unit
6 transmission unit
7 external unit
8 detection unit, output unit and transmission unit as one unit
9 energy supply unit
10 ferroelectric material, dielectric
11a,11b electrodes
12a,12b connection lines
13 coil
14 core
15 magnetically conductive body, ferromagnetic material
G characteristic parameter of the reference element
T temperature
t time
Tₚₕ phase transformation temperature
tₚₕ phase transformation point in time tₚₕ
T_{min/max} predeterminable temperature
t₁, t₂ first, second points in time
B, B₁, B₂ magnetic field
C_{ref} capacitance of the reference element
L_{ref} inductance of the reference element
U_{dyn} voltage, dynamic with time
U₁ voltage
R₁, R₂ resistances
C, C₁ capacitance
L, L₁ inductance
P magnetic or electrical polarization

1-16. (canceled)

17. A system for monitoring a predeterminable temperature, comprising:
a monitoring unit including a reference element composed at least partially of a material in which a phase transformation occurs at a phase transformation temperature which lies in a region of the predeterminable temperature, in which phase transformation the material remains in the solid phase, and
a detection unit which is embodied to detect an occurrence of a phase transformation based on an abrupt change of at least one physical or chemical parameter for the reference element and to generate a report concerning ex- or subceeding of the predeterminable temperature.

18. The system as claimed in claim 17,
wherein the material is a ferroelectric material, a ferromagnetic material, a superconductor, or a high-temperature superconductor.

19. The system as claimed in claim 17,
wherein the physical or chemical parameter is a dielectric, electrical, or magnetic property of the material.

20. The system as claimed in claim 17,
wherein the reference element is a capacitor having a dielectric at least partially composed of the material in which the phase transformation occurs at the phase transformation temperature.

21. The system as claimed in claim 17,
wherein the reference element is a coil arrangement having at least one coil and a magnetically conductive body, wherein the body is composed at least partially of the material in which the phase transformation occurs at the phase transformation temperature.

22. The system as claimed in claim 17,
wherein the detecting unit includes a means for detecting a change of an electric or magnetic field leaving the reference element, and wherein the detecting unit is embodied to detect the ex- or subceeding of the predeterminable temperature based on the change of the electric or magnetic field.

23. The system as claimed in claim 22,
wherein the means for detecting a change of the electric or magnetic field includes a means for detecting a force or a change of a force.

24. The system as claimed in claim 22,
wherein the monitoring unit or the detection unit includes a means for applying an electric or magnetic field.

25. The system as claimed in claim 24,
wherein the detection unit is embodied to detect the ex- or subceeding of the predeterminable temperature based on a hysteresis diagram or based on polarization.

26. The system as claimed in claim 17,
wherein the reference element and at least one other component of the monitoring unit or the detection unit are, at least at times, part of an electrical oscillatory circuit, and
wherein the detecting unit is embodied to detect the occurrence of the phase transformation by a change of a resonant frequency of the oscillatory circuit.

27. The system as claimed in claim 17, further comprising:
an output unit which is embodied to display, to output, and to transmit into an external unit the ex- or subceeding of the predeterminable temperature.

28. The system as claimed in claim 27, further comprising:
a transmission unit including an RFID- or a Bluetooth module which transmission unit is embodied for wireless transmission the ex- or subceeding of the predeterminable temperature.

29. The system as claimed in claim 17, further comprising:
an energy supply unit for supplying electrical power to at least one component of the monitoring unit, the detection unit, the output unit, and the transmission unit.

30. A monitoring unit for application in a system for monitoring a predeterminable temperature, comprising:
a reference element composed at least partially of a material in which a phase transformation occurs at a phase transformation temperature which lies in the region of the predeterminable temperature, in which phase transformation the material remains in the solid phase.

31. A detection unit for application in a system for monitoring a predeterminable temperature, wherein the detection unit is embodied to detect an occurrence of a phase transformation based on an abrupt change of at least one physical or chemical parameter for a reference element and to generate a report concerning ex- or subceeding of the predeterminable temperature.

32. A method for monitoring a predeterminable temperature, comprising:
providing a system for monitoring the predeterminable temperature, including:
a monitoring unit including a reference element composed at least partially of a material in which a phase transformation occurs at a phase transformation temperature which lies in a region of the predeterminable temperature, in which phase transformation the material remains in the solid phase; and
a detection unit which is embodied to detect the occurrence of a phase transformation based on an abrupt change of at least one physical or chemical parameter for the reference element and to generate a report concerning ex- or subceeding of the predeterminable temperature;
detecting a phase transformation based on an abrupt change of a physical or chemical parameter for the reference element, and
generating a report concerning ex- or subceeding of the predeterminable temperature when a phase transformation is detected.
